(19) United States
(12) Patent Application Publication
(10) Pub. No.: US 2018/0326487 A1
(43) Pub. Date: Nov. 15, 2018

(54) LAYER-BY-LAYER CONSTRUCTION METHOD AND LAYER-BY-LAYER CONSTRUCTION APPARATUS FOR THE ADDITIVE MANUFACTURE OF AT LEAST ONE REGION OF A COMPONENT

(71) Applicant: MTU Aero Engines AG, Munich (DE)

(72) Inventors: Johannes Casper, Muenchen (DE); Joachim Bamberg, Dachau (DE); Herbert Hanrieder, Hohenkammer (DE); Guenter Zenzinger, Waakirchen (DE)

(73) Assignee: MTU Aero Engines AG, Munich (DE)

(21) Appl. No.: 15/977,896

(22) Filed: May 11, 2018

(30) Foreign Application Priority Data
May 15, 2017 (DE) 10 2017 208 092.2

(51) Int. Cl. B22F 3/105; B22F 7/06; H05B 6/10; B22F 3/00; B22F 3/10

(52) U.S. Cl. CPC B22F 3/1055; B22F 7/06; B33Y 30/00; B22F 3/003; B22F 3/1017; H05B 6/10

(57) ABSTRACT

The invention relates to a layer-by-layer construction method for the additive manufacture of at least one region of a component. The layer-by-layer construction method comprises at least the following steps: a) application of at least one powder layer of a metallic and/or intermetallic material onto at least one buildup and joining zone of at least one lowerable building platform; b) layer-by-layer and local melting and/or sintering of the material for the formation of a component layer by selective exposure of the material with at least one high-energy beam in accordance with a predetermined exposure strategy; c) layer-by-layer lowering of the building platform by a predefined layer thickness; and d) repetition of steps a) to d) until the component region has been finished. The invention further relates to a layer-by-layer construction apparatus for the additive manufacture of at least one region of a component by an additive layer-by-layer construction method.

### BACKGROUND OF THE INVENTION

The invention relates to a layer-by-layer construction method and a layer-by-layer construction apparatus for the additive manufacture of at least one region of a component.

Additive layer-by-layer construction methods refer to processes in which, on the basis of a virtual model of a component or a component region that is to be manufactured, geometric data that are divided into layer data (so-called “slices”) are determined. Depending on the geometry of the model, an exposure strategy is determined, in accordance with which the selective solidification of a material is to be produced. Besides the number and arrangement of the exposure vectors, for example, strip exposure, island strategy, etc., the exposure strategy comprises additional process parameters, such as, for example, the power of a high-energy beam used for the solidification. In accordance with the exposure strategy, the desired material is then deposited layer by layer and solidified selectively by at least one high-energy beam in order to build up the component region additively. Accordingly, additive or generative manufacturing methods differ from conventional material-removing or primary shaping methods. Examples of additive manufacturing methods are generative laser sintering methods and laser melting methods, which can be used for the manufacture of components for turbomachines, such as aircraft engines. In selective laser melting, thin powder layers of the material or materials employed are deposited onto a building platform and melted and solidified locally in the region of a buildup and joining zone by use of one or a plurality of laser beams. The building platform is then lowered and another powder layer is applied and again locally solidified. This cycle is repeated until the finished component or the finished component region is obtained. The component can afterwards be further processed as needed or else used immediately. In selective laser sintering, the component is produced in a similar way by laser-assisted sintering of powdered materials.

However, during the additive processing, as in the case of any other fabrication method, process-typical flaws arise, which, in the case of additive layer-by-layer construction methods, comprise, for example, cracks, binding flaws, inclusions, and the like. In particular, in the processing of high-temperature materials, such as, for instance poorly weldable nickel-based alloys, (hot) cracks are additionally formed. However, said cracks cannot be reliably detected, as a rule, with modern-day process monitoring, because additively manufactured components or component regions usually have complex geometries with component surface regions that are strongly curved.

### SUMMARY OF THE INVENTION

The object of the present invention is to create an additive layer-by-layer construction method that makes possible an improved process monitoring. Another object of the invention consists in making available a layer-by-layer construction apparatus that makes possible the additive manufacture of components or component regions with improved process monitoring.

The objects are achieved in accordance with the invention by a layer-by-layer construction method as well as by a layer-by-layer construction apparatus of the present invention. Advantageous embodiments with appropriate enhancements of the invention are presented in the respective dependent claims, wherein advantageous embodiments of the layer-by-layer construction method are to be regarded as advantageous embodiments of the layer-by-layer construction apparatus, and vice versa.

A first aspect of the invention relates to a layer-by-layer construction method for the additive manufacture of at least one region of a component, in which at least the following steps are carried out: a) application of at least one powder layer of a metallic and/or intermetallic material onto at least one buildup and joining zone of at least one lowerable building platform; b) layer-by-layer and local melting and/or sintering of the material for the formation of a component layer by selective exposure of the material with at least one high-energy beam in accordance with a predetermined exposure strategy; c) layer-by-layer lowering of the building platform by a predefined layer thickness; and d) repetition of steps a) to d) until the component region has been finished. An improved process monitoring is made possible in accordance with the invention in that, during the production of the component region, at least one component layer is heated by generating eddy currents in the component layer, at least one image of the component layer is acquired by a camera system, wherein the image characterizes a temperature distribution in the component layer, and, by a computing device, the presence of at least one flaw is checked on the basis of the at least one acquired image. Through the induction of an eddy current in the component layer or in the already built-up semifinished product, said component layer or semifinished product is heated. The heating is recorded through the acquisition of one or a plurality of images. In this way, flaws of near-surface type, such as cracks, binding flaws, and inclusions, as well as other defective sites in the component layer or in the hitherto already built-up semifinished product show a characteristic signature, because they influence the temperature development in the semifinished product and therefore can be identified reliably during the following inspection for flaws. For example, the current lines of the generated eddy current, which normally extend concentrically in a homogeneous material, are directed around the crack in the case of a crack. In this way, the current density at the crack tip is increased, which, in turn, leads to a local temperature increase, which is recorded in the acquired image. This applies correspondingly to other inhomogeneities and types of flaws. Moreover, the checking for flaws need not occur, as has hitherto been the case, at the conclusion of the manufacture of the component or component region, but rather is carried out one time or a plurality of times—for example, for a plurality of produced component layers or for each produced component layer—during the additive manufacturing process, so that, in the event of a flaw, it is possible to respond immediately and it is not necessary to wait until after the conclusion of the manufacturing process. In this case, the inspection for flaws can fundamentally occur after a component layer is finished, but it can also occur during the production of a component layer. In the latter case, a first region of the powder layer is solidified locally to form a component layer of the component region that is to be produced, while, at the same time, at least one second region of the component region under consideration during the manufacture is checked in the above-described way by inducing eddy currents and analyzing an acquired image for the presence of flaws. Further advantages lie in the short inspection times, in the contact-free flaw inspection, and in the high detection sensitivity, because it is also possible to detect flaw sites beneath the surface or in deeper-lying component layers as well as in areas that are not accessible by use of other sensors or inspection methods on account of geometric limitations. Furthermore, the flaw inspection according to the invention is especially insensitive in regard to radiation or emission differences at the inspected surface, because the heat arises directly in the semifinished product.

In an advantageous embodiment of the invention, it is provided that the at least one component layer is heated by applying electric current to at least one induction coil, which is moved in relation to the component layer. In this case, eddy currents can be induced in an especially simple and flexible manner. In this case, the mean relative speed between the induction coil and the component layer can be, for example, between 1 mm/s and 250 mm/s, that is, for example, 1 mm/s, 5 mm/s, 10 mm/s, 15 mm/s, 20 mm/s, 25 mm/s, 30 mm/s, 35 mm/s, 40 mm/s, 45 mm/s, 50 mm/s, 55 mm/s, 60 mm/s, 65 mm/s, 70 mm/s, 75 mm/s, 80 mm/s, 85 mm/s, 90 mm/s, 95 mm/s, 100 mm/s, 105 mm/s, 110 mm/s, 115 mm/s, 120 mm/s, 125 mm/s, 130 mm/s, 135 mm/s, 140 mm/s, 145 mm/s, 150 mm/s, 155 mm/s, 160 mm/s, 165 mm/s, 170 mm/s, 175 mm/s, 180 mm/s, 185 mm/s, 190 mm/s, 195 mm/s, 200 mm/s, 205 mm/s, 210 mm/s, 215 mm/s, 220 mm/s, 225 mm/s, 230 mm/s, 235 mm/s, 240 mm/s, 245 mm/s, or 250 mm/s, wherein corresponding intermediate values are to be regarded as being disclosed as well. It is fundamentally possible in this way to provide that the induction coil is operated with a constant electric current and is moved over the component layer in order to induce eddy currents. This is advantageous, in particular, for long component regions. Alternatively, the induction coil can be operated with an electric current changed over time and can be moved relative to the component layer or not moved relative to the component layer in order to induce eddy currents therein. This is advantageous, in particular, for short component regions. A relatively short-term effect of the magnetic field should be aimed at in this case, either by way of the choice of the speed and/or by way of the current flow through the induction coil in general, in order to avoid a strong attenuation or leveling of the thereby resulting temperature increase on account of the heat conduction in the semifinished product, as a result of which the detectability of any defects would be affected detrimentally. Because, in any case, layer-by-layer construction apparatuses often comprise inductive heating devices, it is possible for one or a plurality of induction coils that is or are already present to be used advantageously for the generation of eddy currents in the scope of flaw inspection, as a result of which corresponding cost reductions can be realized.

In another embodiment, it can be provided that at least one induction coil is positioned depending on a component geometry. This permits an improved detection of any flaws or defects.

Further advantages ensue in that electric current is applied to at least one additional induction coil, which is moved in relation to the component layer and/or in relation to the first induction coil. For example, for this purpose, it is possible to use a heating device with a so-called cross coil arrangement, in which two or more induction coils can move in relation to one another for targeted overlap or attenuation of their fields. Alternatively or additionally, it can be provided that, by the at least one induction coil, the powdered material is heated before, during, and/or after step b). Accordingly, besides a preheating of the material for a subsequent layer-by-layer construction, it is also possible to adjust the contrast in regard to the component layer to be heated for the acquisition of the image.

The at least one component layer is heated in that a pulsed high-frequency magnetic field is in-coupled for a predetermined period of time. In this way, it is possible to adjust the temperature signal that is to be generated and the flaw inspection based on it to different component geometries, materials, and depth regions for defect detection in an especially simple way.

It has hereby been shown to be advantageous when a pulse duration of the high-frequency magnetic field and/or the predetermined period of time is/are between 50 ms and 2 s, that is, for example, 50 ms, 100 ms, 150 ms, 200 ms, 250 ms, 300 ms, 350 ms, 400 ms, 450 ms, 500 ms, 550 ms, 600 ms, 650 ms, 700 ms, 750 ms, 800 ms, 850 ms, 900 ms, 950 ms, 1000 ms, 1050 ms, 1100 ms, 1150 ms, 1200 ms, 1250 ms, 1300 ms, 1350 ms, 1400 ms, 1450 ms, 1500 ms, 1550 ms, 1600 ms, 1650 ms, 1700 ms, 1750 ms, 1800 ms, 1850 ms, 1900 ms, 1950 ms, or 2000 ms. In this way, depending on the particular circumstances, it can be reliably ensured that the thermal conduction for the inspection for flaws in the semifinished product is negligible. Alternatively or additionally, it is provided that the high-frequency magnetic field is in-coupled repeatedly for a respectively predetermined period of time. In this way, it is possible to improve the signal-to-noise ratio, which makes possible a correspondingly more reliable flaw inspection.

An especially reliable heating and, accordingly, a correspondingly especially reliable inspection for flaws is ensured in another embodiment of the invention in that the high-frequency magnetic field is generated by a high-frequency generator, wherein the high-frequency generator is operated with a frequency of between 1 kHz and 1000 kHz, that is, for example, 1 kHz, 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 100 kHz, 150 kHz, 200 kHz, 250 kHz, 300 kHz, 350 kHz, 400 kHz, 450 kHz, 500 kHz, 550 kHz, 600 kHz, 650 kHz, 700 kHz, 750 kHz, 800 kHz, 850 kHz, 900 kHz, 950 kHz, or 1000 kHz. Alternatively or additionally, it can be provided that the high-frequency generator is operated with a power of at least 0.1 kW, that is, for example, with 0.1 kW, 0.2 kW, 0.3 kW, 0.4 kW, 0.5 kW, 0.6 kW, 0.7 kW, 0.8 kW, 0.9 kW, 1.0 kW, 1.5 kW, 2.0 kW, 2.5 kW, 3.0 kW, 3.5 kW, 4.0 kW, 4.5 kW, 5.0 kW, 5.5 kW, 6.0 kW, 6.5 kW, 7.0 kW, 7.5 kW, 8.0 kW, 8.5 kW, 9.0 kW, 9.5 kW, 10.0 kW or more.

Further advantages ensue in that the at least one component layer is heated during and/or after step b) by generating eddy currents. In other words, the flaw inspection method according to the invention can be carried out generally during a solidification step and/or after a solidification step, as a result of which an especially flexible inspection is made possible.

In another advantageous embodiment of the invention, it is provided that, during inspection for flaws, the computing device compares the at least one acquired image with a reference image and/or a component layer structure is determined on the basis of the acquired image and/or edge areas of the component layer are taken into consideration during the inspection. This allows an especially reliable and automated analysis of the acquired image.

Further advantages ensue in that a plurality of images of the heated component layer are acquired in succession by the camera system, wherein the images characterize a development over time of the temperature distribution of the component layer, and in that, by the computing device, the presence and/or the nature of at least one flaw is checked on the basis of a plurality of acquired images. In this way, it is possible, through a kind of series photography, to carry out an especially precise and reproducible inspection for flaws, because the time course of the heat distribution in the component layer or in the semifinished product can be taken into consideration over a predetermined period of time or in predetermined intervals.

In another advantageous embodiment of the invention, it is provided that, by the computing device, depending on the inspection for flaws, the exposure strategy is determined and/or adjusted for a renewed exposure of the component layer and/or for at least one following component layer. In this way, flaws that are identified in the component layer can be immediately remedied depending on the type and extent thereof in that the component layer is (re)exposed anew with a correspondingly adjusted exposure strategy and/or in that the exposure strategy of one or a plurality of successive component layers is altered and/or adjusted. In this way, it is possible to reduce substantially the fraction of rejects of the layer-by-layer construction method, as a result of which corresponding advantages in terms of time and cost can be realized.

A second aspect of the invention relates to a layer-by-layer construction apparatus for the additive manufacture of at least one region of a component by an additive layer-by-layer construction method, which comprises at least one powder feed for the application of at least one powder layer of a material onto a buildup and joining zone of a movable building platform and at least one radiation source for generating at least one high-energy beam for layer-by-layer and local melting and/or sintering of the material for the formation of a component layer by selective exposure of the material with the at least one high-energy beam in accordance with a predetermined exposure strategy. In accordance with the invention, it is provided that the layer-by-layer construction apparatus additionally comprises at least one heating device, which is designed to heat at least one component layer by generating eddy currents in the component layer. Furthermore, the layer-by-layer construction apparatus according to the invention comprises a camera system, which is designed to acquire at least one image of the heated component layer, wherein the image characterizes a temperature distribution of the component layer, and at least one computing device, which is designed, to check for the presence of at least one flaw on the basis of the acquired image. In this way, the layer-by-layer construction apparatus makes possible an improved process monitoring, because, during the production of the component region, at least one component layer is heated by generating eddy currents in the component layer and at least one image of the component layer can be acquired by the camera system, wherein the image characterizes a temperature distribution of the component layer. By the computing device, it is possible, on the basis of the at least one acquired image, to check for the presence of at least one flaw. As a result of the induction of an eddy current in the component layer or in the already built-up semifinished product, said component layer or said semifinished product heats up. The heating can then be recorded through the acquisition of one or a plurality of images. Types of flaws that are near to the surface, such as cracks, binding flaws, and inclusions, as well as other flaw sites in the component layer or in the previously already built-up semifinished product in this case show a characteristic signature, because they influence the temperature development in the semifinished product and, therefore, in the following inspection for flaws, they can be reliably identified. For example, in the case of a crack, the lines of current of the generated eddy current, which normally extend concentrically in a homogeneous material, are directed around said crack. As a result, the current density at the crack tip increases, which, in turn, leads to a local temperature increase, which can be recorded in the acquired image. This applies correspondingly to other inhomogeneities and types of flaws. In addition, the inspection for flaws need not occur subsequently to the manufacture of the component or component region, as was previously the case, but can be carried out one or a plurality of times—for example, for a plurality of produced component layers or for each produced component layer—during the additive manufacturing process, so that, in the event of a flaw, it is possible to respond immediately and it is not necessary to wait until the conclusion of the manufacturing process. Further advantages lie in the short inspection time, in the contact-free flaw inspection, and in the high detection sensitivity, because it is also possible to detect flaw sites beneath the surface or in deeper-lying component layers as well as in regions that are not accessible by the use of other sensors or inspection methods on account of geometric limitations. Furthermore, the inspection for flaws is especially insensitive to radiation or emission differences on the inspected surface, because the heat arises directly in the semifinished product. In the scope of the present invention, the expression “designed to/for” is to be understood to mean that the device in question is not only suitable in general, but is also furnished and configured in a specifically hardware- and software-based manner to carry out the respectively mentioned steps. The layer-by-layer construction apparatus can also comprise a fundamentally optional control apparatus. The control apparatus can have a processor device, which is furnished to carry out one embodiment of the method according to the invention. For this purpose, the processor device can have at least one microprocessor and/or at least one microcontroller. Furthermore, the processor device can have program code, which is written to carry out the embodiment of the method according to the invention by way of the processor device when the program code is executed. The program code can be stored in a data memory of the processor device. The data memory provided with the program code can accordingly also be regarded as an independent aspect of the invention.

In an advantageous embodiment of the invention, it is provided that the layer-by-layer construction apparatus comprises a generative laser-sintering and/or laser-melting device, by which the at least one component layer can be produced. In this way, it is possible to produce subregions, the mechanical properties of which correspond at least largely to those of the component material. For generation of the laser beam, it is possible to provide, for example, a CO₂ laser, an Nd:YAG laser, a Yb fiber laser, a diode laser, or the like. It can likewise be provided that two or more laser beams are used. Depending on the component material and the exposure strategy, a melting and/or a sintering of the powder can occur during exposure, so that, in the scope of the present invention, the term “welding” can also be understood to mean “sintering”, and vice versa.

In another advantageous embodiment of the invention, it is provided that the camera system comprises a thermographic camera, in particular a thermal imaging camera, which is designed for acquiring images in the wavelength range of 0.5 μm to 10 μm, that is, for example, at 0.5 μm, 1.0 μm, 1.5 μm, 2.0 μm, 2.5 μm, 3.0 μm, 3.5 μm, 4.0 μm, 4.5 μm, 5.0 μm, 5.5 μm, 6.0 μm, 6.5 μm, 7.0 μm, 7.5 μm, 8.0 μm, 8.5 μm, 9.0 μm, 9.5 μm, or 10.0 μm. This permits a highly precise recording of the individual layers of the component or component region. In particular, optical tomography (OT) is a high-performance, non-destructive method for monitoring the layer-by-layer construction method during the additive manufacture. Process disruptions during the heating of the component layer, which are revealed in the form of non-uniform or incorrect temperatures or temperature distributions, can be reliably identified and used for flaw inspection. Therefore, both the camera system and the computing device can be a part of an optical tomography system.

Further advantages ensue when the layer-by-layer construction apparatus comprises a heating device with at least two induction coils that can be moved independently of one another. The at least two induction coils can fundamentally be moved in a translational manner and/or in a rotational manner in relation to one another, as a result of which their relative positioning with respect to each other can be adjusted in a manner that is especially precise and is appropriate to need. This permits a correspondingly precise heating of the component layer and, in particular, it is possible to superimpose the magnetic fields of the induction coils specifically in desired regions.

Further advantages ensue in that the layer-by-layer construction apparatus comprises a storage device, which comprises at least one reference image, which, by the computing device, is to be compared with the at least one image to be acquired in order to check for the presence of at least one flaw. A reference image that is hereby understood to mean an image of an earlier flaw-free component layer that corresponds to the component layer of the current component that is to be checked. This makes possible a largely or completely automated inspection for flaws, because the acquired image or images can be compared with the reference image or reference images and, in the event of an unallowed deviation, it can be concluded that a flaw is present.

### BRIEF DESCRIPTION OF THE DRAWING FIGURES

Additional features of the invention ensue from the claims, the figures, and the description of the figures. The features and combinations of features mentioned above in the description as well as the features and combinations of features mentioned below in the description of the figures and/or shown below solely in the figures can be used not only in the respectively given combination, but also in other combinations, without departing from the scope of the invention. Accordingly, the invention also comprises and is regarded as disclosing configurations that are not explicitly shown and explained in the figures, but can ensue and be created from the explained configurations through separate combinations of features. Configurations and combinations of features that thus do not have all features of an originally formulated independent claim are also to be regarded as disclosed. Beyond this, configurations and combinations of features, in particular those ensuing from the configurations illustrated above that go beyond or depart from the combinations of features presented in the back-references of the claims are also to be regarded as disclosed. Shown herein are:

FIG. 1 a schematic cutout view of a layer-by-layer construction apparatus according to the invention;

FIG. 2 a schematic perspective view of an induction coil arranged above a component layer; and

FIG. 3 a characteristic heat signature of a component layer having a flaw site.

### DESCRIPTION OF THE INVENTION

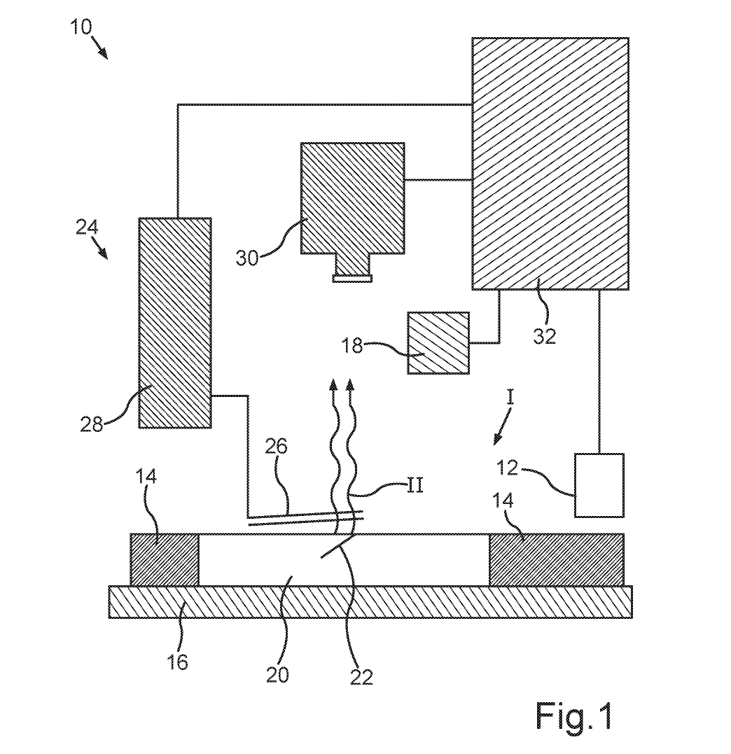

FIG. 1 shows a schematic view of a layer-by-layer construction apparatus 10 according to the invention. The layer-by-layer construction apparatus 10 comprises a powder feed 12 for application of at least one powder layer 14 of a material onto a buildup and joining zone I of a movable building platform 16. The layer-by-layer construction apparatus 10 further comprises a generative laser sintering and/or laser melting device 18 (selective laser melting, SLM), which has at least one radiation source for generating at least one high-energy beam, by which the material is melted and/or sintered through layer-by-layer selective exposure with the at least one high-energy beam in accordance with a predetermined exposure strategy for the formation of a component layer 20.

In order to make possible a layer-by-layer inspection of the component or of the component layer 20 for detecting cracks 22 and other process-typical flaws, the layer-by-layer construction apparatus 10 comprises, in addition, a heating device 24, which is designed for heating one, a plurality of, or all produced component layer(s) 20 by generating eddy currents in the component layer 20. For this purpose, the heating device 24 comprises one or a plurality of induction coils 26, to which electric current is applied by a high-frequency generator 28, wherein the high-frequency generator is operated at a frequency between 1 kHz and 1000 kHz and with a power of at least 0.1 kW. In this way, a pulsed high-frequency magnetic field is generated, which is in-coupled into the component layer 20 or into the already produced component for a time period of between 50 ms and 0.5 s. Alternatively or additionally, it can be provided that a constant current is applied to the one or the plurality of induction coils 26, which are moved over the component layer(s) 20 in order to generate eddy currents. Depending on the design of the layer-by-layer construction apparatus 10, it is possible to use, as a heating device 24, an SLM heating module, which is frequently present in any case for inductive preheating of the powder layer 14. In this way, it is advantageously possible to dispense with additional hardware, as a result of which, besides a smaller space requirement, also corresponding cost reductions are possible.

Furthermore, the layer-by-layer construction apparatus 10 comprises a camera system 30, which is designed for acquiring at least one image of the heated component layer 20, wherein the image characterizes a temperature distribution of the component layer. For this purpose, the camera system 30 comprises a thermographic camera for taking a temperature image (e.g., in the wavelength range of 0.5-10 μm) on the basis of the IR radiation II radiated from the heated component layer 20. For acquisition of the at least one image, it is fundamentally possible to use an optical tomography device (OT system), which is present anyway in many cases.

Finally, the layer-by-layer construction apparatus 10 comprises a computing device 32, which is designed for checking for the presence of flaws 22 on the basis of the acquired image. For this purpose, it can be provided, for example, that the computing device 32 compares the at least one acquired image with a stored reference image of a corresponding flaw-free component layer 20. For improvement of the identification of complexly shaped geometries, it is possible additionally to determine a component layer contour on the basis of the acquired image and to take into consideration edge areas of the component layer 20 during the inspection for flaws 22.

The described flaw inspection can thereby be carried out fundamentally subsequently to the manufacture of one, a plurality of, or all component layer(s). Alternatively or additionally, the flaw inspection can also be carried out during the manufacture of one, a plurality of, or all component layer(s). In this case, it is possible, for example, to direct the high-energy beam, which is generated by the laser melting device 18, past the induction coil 26 or through a gap in the induction coil 26 onto the underlying powder layer 14 in order to achieve a local solidification. At the same time, it is possible by use of the induction coil 26 to heat inductively a component region that is spaced apart and to investigate it for the presence of flaws. In this way, flaws can be identified especially fast and, if need be, repaired immediately.

In the case that the inspection reveals the presence of a flaw 22, it is possible, regardless of the flaw characteristics, to expose the component layer 20 once again using an adjusted exposure strategy. Alternatively or additionally, the exposure strategy of at least one following component layer 20 can be determined or adjusted in such a way that the flaw 22 is repaired. In the case that the flaw 22 must be classified as “irreparable,” the additive layer-by-layer construction method can be discontinued, without it being necessary first to completely finish the planned component and subsequently to discard it.

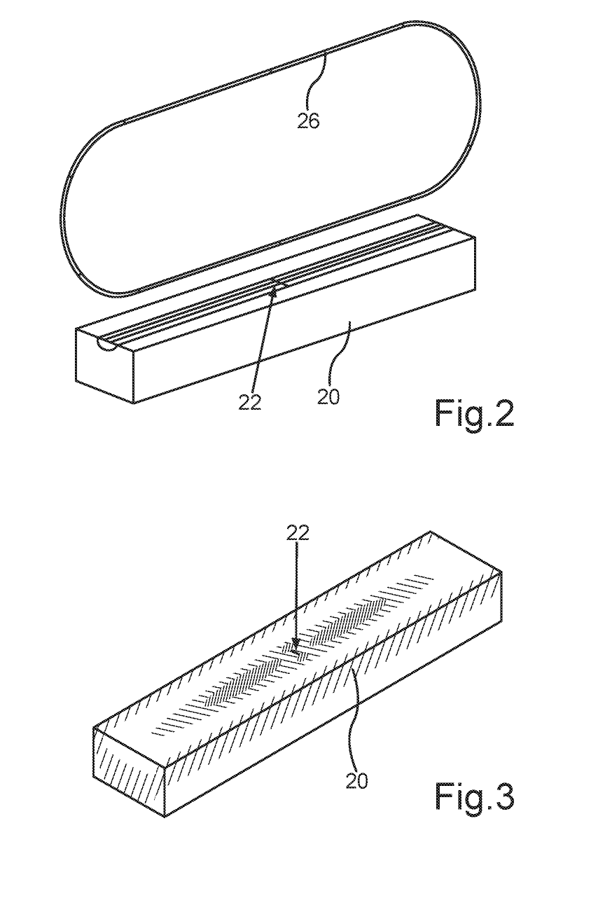

FIG. 2 shows, for further clarification, a schematic perspective view of an induction coil 26 arranged above a component layer 20. As already mentioned, the induction coil 26 is arranged above the component layer 20 or above the already manufactured semifinished product, and a short, pulsed induction current is generated, which leads to the imposition of typical eddy currents in the component layer 20. Alternatively, a constant induction current can be produced, but the induction coil 26 for this can be moved over the component layer 20, which leads to the same thermal effects. Flaws 22 at or just beneath the surface produce typical thermal heat signatures, which are illustrated in FIG. 3 and can be recorded using the thermographic camera 30. It can be seen in FIG. 3 that flaws near to the surface, such as cracks, binding flaws, and inclusions, as well as other flaw sites in the component layer 20 produce a characteristic signal, because they influence the temperature development. For example, in the case of a crack 22, the lines of current of the generated eddy current, which normally extend concentrically in a homogeneous material, are directed around the crack 22. As a result, the current density at the crack tip increases, which, in turn, leads to a local temperature increase, which can be seen in FIG. 3.

The parameter values given in the present documents for definition of process and measurement conditions for the characterization of specific properties of the subject of the invention are also to be regarded in the context of deviations—for example, due to measurement errors, system errors, weighing errors, DIN (industrial standard) tolerances, and the like, as being included in the scope of the invention.

What is claimed is:

1. A layer-by-layer construction method for the additive manufacture of at least one region of a component, comprising at least the following steps:
a) application of at least one powder layer of a metallic and/or intermetallic material onto at least one buildup and joining zone of at least one lowerable building platform;
b) layer-by-layer and local melting and/or sintering of the material for the formation of a component layer by selective exposure of the material with at least one high-energy beam in accordance with a predetermined exposure strategy;
c) layer-by-layer lowering of the building platform by a predefined layer thickness; and
d) repetition of steps a) to d) until the component region has been finished,
wherein, during the manufacture of the component region,
at least one component layer is heated by generating eddy currents in the component layer; and
at least one image of the component layer is acquired by a camera system, wherein the image characterizes a temperature distribution in the component layer; and
by a computing device, the presence of at least one flaw is checked on the basis of the at least one acquired image.

2. The method according to claim 1, wherein the at least one component layer is heated by applying an electric current to at least one induction coil that is moved in relation to the component layer, wherein the mean relative speed between the induction coil and the component layer is between 1 mm/s and 250 mm/s.

3. The method according to claim 2, wherein electric current is applied to at least one additional induction coil that is moved in relation to the component layer and/or in relation to a first induction coil and/or in that the powdered material is heated before, during, and/or after step b) by the at least one induction coil.

4. The method according to claim 1, wherein the at least one component layer is heated by in-coupling a pulsed high-frequency magnetic field for a predetermined period of time.

5. The method according to claim 4, wherein a pulse duration of the high-frequency magnetic field and/or of the predetermined period of time is between 50 ms and 0.5 s and/or in that the high-frequency magnetic field is in-coupled repeatedly for a respectively predetermined period of time.

6. The method according to claim 4, wherein the high-frequency magnetic field is generated by a high-frequency generator, wherein the high-frequency generator is operated at a frequency of between 1 kHz and 1000 kHz and/or with a power of at least 0.1 kW.

7. The method according to claim 1, wherein the at least one component layer is heated during and/or after step b) by generating eddy currents.

8. The method according to claim 1, wherein the computing device compares the at least one acquired image to a reference image during the inspection for flaws, and/or determines a component layer contour on the basis of the acquired image, and/or takes into consideration edge regions of the component layer during the inspection for flaws.

9. The method according to claim 1, wherein a plurality of images of the heated component layer are successively acquired by the camera system, wherein the images characterize a development over time of the temperature distribution of the component layer and in that, by the computing device, the presence and/or the nature of at least one flaw is checked on the basis of a plurality of acquired images.

10. The method according to claim 1, wherein, by the computing device, depending on the inspection for flaws, the exposure strategy for a renewed exposure of the component layer and/or for at least one following component layer is determined and/or adjusted.

11. A layer-by-layer construction apparatus for the additive manufacture of at least one region of a component by an additive layer-by-layer construction method, comprising:
at least one powder feed for the application of at least one powder layer of a material onto a buildup and joining zone of a movable building platform; and
at least one radiation source for generating at least one high-energy beam for layer-by-layer and local melting and/or sintering of the material for the formation of a component layer by selective exposure of the material with the at least one high-energy beam in accordance with a predetermined exposure strategy, wherein
at least one heating device, which is designed to heat at least one component layer by generating eddy currents in the component layer;
a camera system, which is designed to acquire at least one image of the heated component layer, wherein the image characterizes a temperature distribution of the component layer; and
at least one computing device, which is designed to check for the presence of at least one flaw on the basis of the acquired image.

12. The layer-by-layer construction apparatus according to claim 11, wherein the layer-by-layer construction apparatus comprises a generative laser-sintering and/or laser-melting device, by which the at least one component layer can be produced.

13. The layer-by-layer construction apparatus according to claim 11, wherein the camera system comprises a thermographic camera which is configured and arranged for the acquisition of images in the wavelength range of 0.5 μm to 10 μm.

14. The layer-by-layer construction apparatus according to claim 11, wherein the layer-by-layer construction apparatus comprises a heating device with at least two induction coils that can move independently of one another.

15. The layer-by-layer construction apparatus according to claim 11, wherein the layer-by-layer construction apparatus comprises a storage device, which comprises at least one reference image, which, by the computing device, is to be compared with the at least one image that is to be acquired in order to check for the presence of at least one flaw.
